(19) United States
(12) Patent Application Publication
(10) Pub. No.: US 2024/0178585 A1
(43) Pub. Date: May 30, 2024

(54) DEVICE AND METHOD FOR THE CONTACTING OF A CONDUCTOR

(71) Applicant: LISA DRÄXLMAIER GMBH, Vilsbiburg (DE)

(72) Inventors: Georg VÖLLNER, Landshut (DE); Thomas HERZING, Landshut (DE)

(73) Assignee: LISA DRÄXLMAIER GMBH, Vilsbiburg (DE)

(21) Appl. No.: 18/432,673

(22) Filed: Feb. 5, 2024

Related U.S. Application Data
(63) Continuation of application No. PCT/EP2022/071291, filed on Jul. 28, 2022.

(30) Foreign Application Priority Data
Aug. 4, 2021 (DE) 102021120217.5

(51) Int. Cl. H01R 4/62; H01R 43/02

(52) U.S. Cl. CPC H01R 4/625; H01R 43/0207; H01R 43/0214

(57) ABSTRACT

A device for the contacting of a conductor with an electrical component with a flat conductor made of aluminum includes a contacting element, which is connectable with the flat conductor in a material-bonded manner. The contacting element is formed of copper and configured as a disk, in which the disk includes a friction aid configured as a conical or annular structure on a first side, referred to as a joint side, and an outer contour, provided with at least one opening, on a second side opposite the joint side of the disk, for the receiving of the disk in an insertion contour corresponding to a welding tool.

### CROSS-REFERENCE TO RELATED APPLICATIONS

This application is a continuation of International Application No. PCT/EP2022/071291, filed on Jul. 28, 2022, which claims priority to and the benefit of DE 10 2021 120 217.5 filed on Aug. 4, 2021. The disclosures of the above applications are incorporated herein by reference.

### FIELD

The present disclosure relates to a device and a method for the contacting of an electrical conductor with an electrical component.

### BACKGROUND

The statements in this section merely provide background information related to the present disclosure and may not constitute prior art.

The use of flat conductors made of aluminum as current rails or multi-rails for the transmission of high currents and voltages in the field of vehicle technology continues to increase in importance. These flat conductors are electrically connected at their ends to electrical components, such as, for example, a battery or a charging socket. However, as has long been known from the prior art, aluminum, due to its physical properties, such as, for example, its plastic flow behavior under pressure, is not suitable for direct contacting with an existing electrical component.

DE102014012489 A1 shows a terminal component, formed as a flange, for aluminum conductors that are welded-in to a bored flat conductor and subsequently contacted.

### SUMMARY

This section provides a general summary of the disclosure and is not a comprehensive disclosure of its full scope or all of its features.

The present disclosure provides a device and a method for the direct contacting of a conductor, in particular made of aluminum, with an electrical component.

The present disclosure provides a device and a method in which a contacting element configured as a so-called adapter element is applied onto a current rail configured as an aluminum flat conductor for secure contacting of the current rail with an electrical component. Here, the contacting element can be coated with silver or copper, or be configured as a disk comprised of copper, which is applied onto a surface, stripped of insulation, of the aluminum flat conductor by using a conventional welding method, such as, for example, rotation welding, ultrasound welding, or resistance welding. The contacting of the current rail with an electrical component can then be affected using the adapter element or contact element via a corresponding friction-fit or interference-fit.

According to one aspect of the present disclosure, the disclosure relates to a device for the contacting of a conductor, made of aluminum, configured as a flat conductor, with an electrical component using a contacting element, which is connectable by material bond with the flat conductor, in which the contacting element is comprised of copper. Here the contacting element is configured as a disk, in which on one side of the disk includes a friction aid, configured as a conical or annular structure, on a first side of the disk, which first side is designated as a joint side. On the other side, the disk incudes an outer contour, provided with at least one opening, on a second side opposite the joint side of the disk, for the receiving of the disk in an insertion contour corresponding to a welding tool.

Due to the friction aid, configured as conical or annular structure, of the disk, the advantage is achieved that during the connecting of the disk with the insulated flat conductor using a suitable welding process, the oxides of the aluminum surface of the flat conductor are either driven into the center of the disk, where the oxides or burrs can be securely removed by a processing following the welding process, the processing is in particular the boring-through of the disk welded-on to the flat conductor, or driven outward, where they can be captured by an encircling collar. Generally speaking, the oxides are thus already located on the aluminum surface of the flat conductor and are urged outward or inward by the contour of the disk.

Generally, the friction aid of the disk can also have a welding-hump shape, under which the conical or annular structure of the disk falls.

Here the disk can be configured relatively flat compared to a conventional, generally cylindrically configured flange. In this way, in an advantageous manner a smaller installation space is used with the same available contact surface. The installation space can thus be improved by the disk in accordance with the respective application. A relatively flat disk also calls for a significantly lower material usage.

In one form the at least once opening of the outer contour of the disk is configured as a notch. The advantage is thereby achieved that the disk can be inserted simply in an interference-fit manner in an existing welding tool for the connecting of the disk with the flat conductor. A further advantage is that the welding tool can be better positioned on the disk. In addition, the welding process is thereby made more reliable in terms of process.

In one form the at least one opening of the outer contour of the disk incudes at least one angularly configured section or at least one longitudinally configured section. The advantage is thereby achieved that the disk can be simply inserted in an interference-fit manner into an existing welding tool for the connecting of the disk with the flat conductor.

Due to this particular form of the outer contour, which is also referred to here as the shape contour of the disk, in addition an angularly precise welding-on of the disk onto the flat conductor can be made possible. In addition, a so-called coding of the disk for a welding point or a possible plug contact can be realized by the shape contour of the disk.

In one form, the disk includes an essentially centrally oriented bore, in which the bore is, in one form, configured as a slot. The advantage is thereby achieved that a flexible contact spacing to a counter-plug can be set in order to realize a tolerance compensation in a simple manner. In general, the contact surface of the disk can advantageously be screwed in a large-surface manner through a bore hole in the disk. The boring of the disk is generally affected after the joining of the disk with the flat conductor.

In one form the disk is either partially silvered, nickel-plated, or partially tinned. The advantage of an improved contacting to the terminal element is thereby achieved.

According to a second aspect of the present disclosure, the disclosure relates to a method for the material-bonded contacting of a conductor with a contacting element for the subsequent friction-fit contacting with an electrical component. In a first step, a flat conductor made of aluminum is provided. In a second step, the flat conductor is connected in a material-bonded manner with a contacting element, in which the contacting element is comprised of copper, and in which the contacting element is configured as a disk, in which the disk includes a friction aid, configured as conical or annular structure, on a first side, referred to as a joint side, of the disk, and an outer contour, provided with at least one opening, on a second side, opposite the joint side of the disk, for the receiving of the disk in an insertion contour corresponding to a welding tool.

In one form according to the second aspect of the present disclosure, the method step of the material-bonded connecting is affected by rotation friction welding, ultrasound welding, or resistance welding.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a perspective view of a device for the contacting of a conductor in one form according to the present disclosure;

FIG. 2A shows a top view of a tool-side shape contour of a contacting element in one form according to the present disclosure;

FIG. 2B shows a top view of a tool-side shape contour of a contacting element in one form according to the present disclosure;

FIG. 2C shows a top view of a tool-side shape contour of a contacting element in one form according to the present disclosure;

FIG. 3A shows a side view of a friction aid of a contacting element in one form according to the present disclosure;

FIG. 3B shows a side view of a friction aid of a contacting element in one form according to the present disclosure;

FIG. 4 shows a perspective view of a contacting element in one form according to the present disclosure;

FIG. 5 shows a perspective view of a processing process of the device in one form according to the present disclosure;

FIG. 6 shows a perspective view of a contacting element in one form according to the present disclosure; and

FIG. 7 schematically shows a method for the contacting of a conductor in one form according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

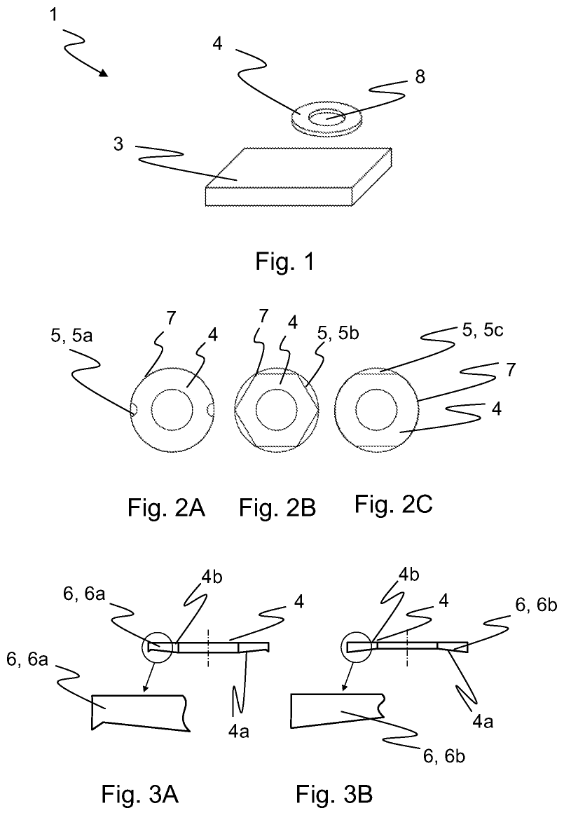

FIG. 1 shows a device 1 for the contacting of a conductor, configured as flat conductor 3 made of aluminum, in one form. A contacting element 4, which is configured as a disk 4, made, in one form of copper, comprises a bore hole 8 disposed centrally or in the center of the disk 4. After the occurrence of welding, in which the disk 4 is applied in a material-boned manner onto the surface of the flat conductor 3, stripped of insulation, the circular bore is seated, and makes possible the removing of a burr arising during the welding process.

Generally, in the sense of the present disclosure, the disk 4 includes a friction aid 6, configured as conical or annular structure (see FIG. 3A an FIG. 3B), on a first side 4a, referred to as joint side 4a, of the disk 4.

Furthermore, the disk 4 includes an outer contour, provided with at least one opening 5, on a second side 4b, opposite the joint side 4a, of the disk 4 (see FIGS. 2A, 2B, 2C, as well as FIGS. 3A and 3B) for the receiving of the disk 4 for in an insertion contour (not shown) corresponding to a welding tool, in order to be connected with an electrical component (not depicted), such as, for example, a battery or a charging socket.

FIGS. 2A, 2B, and 2C show various examples for tool-side shape contours of the inventive contact element 4.

FIG. 2A shows a first tool-side shape contour of the contacting element 4 in a first form. Here the disk 4 includes on its outer contour 7 a first notch, configured as opening 5, and a second notch 5a.

FIG. 2B shows a further tool-side shape contour of the inventive contacting element 4 in a second form. Here the disk 4 includes, on its outer contour 7, an angularly formed section 5b, configured as opening 5, which characterizes the shape of the disk 4 as a hexagon. Other multi-toothed or many-toothed projections, and/or projections additionally provided with wave-shaped or curve-shaped sections, of the openings 5 of the outer contour 7 of the disk 4, for example, in a pentagonal shape or a heptagonal shape, are likewise conceivable and not restricted thereto.

In FIG. 2C one form of the disk 4 is shown in which the opening 5 of the outer contour 7 of the disk 4 includes a plurality of longitudinally configured sections 5c.

These tool-side shape contours 5a, 5b, 5c of the disk 4 advantageously make possible a simple insertion of the disk 4 into a welding tool (not depicted).

FIG. 3A shows a friction aid 6 of a contacting element 4 in a first form in relation to a flat conductor 3, on whose surface the contacting element 4 is applied by welding. Here the disk 4 includes a friction aid 6, configured as a conical or annular structure 6a, on a first side 4a of the disk 4.

FIG. 3B shows a disk 4, which includes a friction aid 6, configured as another conical or annular structure 6b, on a first side 4a of the disk 4.

In principle, the first side 4a of the disk 4, i.e., the friction aid 6, can have a welding-hump and/or semicircular shape. The shape of the friction aid 6 can thus always be designed such that oxides of the aluminum surface of the flat conductor 3 is driven into the center of the disk 4, where the oxides can then be more easily removed as a burr. The welding-hump-like and/or semicircular shape of the friction aid 6 results in the welding process starting at a linear or circular contour and the available welding surface becomes larger, and an improved displacement of the oxide layer thereby also results. The layer, comprising oxides, on the aluminum surface of the flat conductor 3, is thus removed and transported away by the welding process.

The underside of the disk 4, i.e., the joint surface 4a, is thus provided with a flat, conical surface, which either is superelevated at the outer circumference, and oxide layers are displaced inward during the welding process, or the conical surface is superelevated at the inner diameter of the disk 4, and oxide layers are displaced outward. In the latter case the displaced material is captured by an encircling collar or sheared off by encircling teeth.

If the material is displaced inward by the cone geometry, this burr/ejected material is removed by the subsequent boring of the flat conductor 3. Since the boring occurs afterward, the welding process is carried out on solid material, which represents more stable process conditions than with an already perforated rail. Due to the welding processes of aluminum, the aluminum reaches into the plastic region and flows quickly and in an uncontrolled manner into regions with lesser, lateral support.

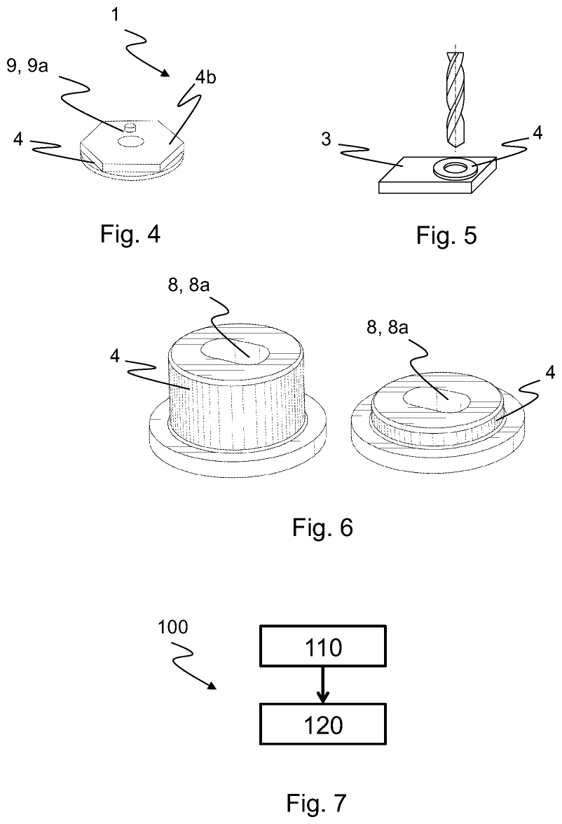

FIG. 4 shows a contacting element 4 in one form, in which the disk 4 has a shape contour 9 for the realizing of a coding of a contacting point 9a of the disk 4. An angularly precise positioning of the disk 4 prior to the welding process is thereby made possible or facilitated.

With suitable counter-position, the surface of the disk 4 can also be equipped with one or more pins or recesses in order to realize a coding (poka-yoke) for the later contacting. This coding can also be incorporated in the welding tool and then angularly precisely positioned at the end of the welding—the component is angularly precisely connected onto the rail in a materially-bonded manner.

FIG. 5 shows a processing process of the device 1 in one form before a bore is seated, in one form, centrally or in the center of the disk 4, by a corresponding tool and after an already performed welding process for the material-bonded attaching of the disk 4 onto the surface, stripped of insulation, of the flat conductor 3. A screw contacting is thereby made possible. Prior to the welding process, the aluminum flat conductor 3 does not yet have a bore that is congruently positioned for the boring of the disk 4. Thus, desired positional tolerances for the welding process can be omitted.

The further advantages of a boring of the aluminum rail after the welding process of the disk 4 onto the flat conductor 3 are: wider positional tolerances during the welding process; and reducing high tolerances requirements for the boring.

If a bushing is welded into a bored rail, the outer diameter of a welded-in bushing/flange may have a very narrow tolerance window. In such a case the gap dimensions may be very small and constant, so that on the one hand a touching of the bore wall is inhibited. On the other hand, the gap dimensions must not be so large that material can flow away in an undefined manner and the process monitoring becomes imprecise.

Further advantages of a boring of the flat conductor 3 are wider positional tolerances during the welding process. In addition, tight tolerances are also not placed on the boring. If a bushing is welded into a bored rail, then the outer diameter of a welded-in bushing or of the flange may have a very narrow tolerance window. In such a case, the gap dimensions may be very small and constant such that a touching of the bore wall is inhibited.

FIG. 6 shows a contacting element 4 in one form in which the disk 4 includes an essentially centrally oriented bore 8, and in which in this specific form the bore 8 is configured as a slot 8a. A tolerance compensation or a flexible contact spacing is thereby settable in a particularly simple manner. Here the disk 4 can have a height profile that varies depending on the form, as is depicted by way of example in the left and right form of the disk 4 of FIG. 6.

FIG. 7 schematically shows a method 100 for the contacting of a conductor 3 in one form. In a first method step 110, a flat conductor 3 made of aluminum is provided. In a second method step 120, the flat conductor 3 is connected with a contacting element 4 in a materially bonded manner, in which the contacting element 4 is comprised of copper, and in which the contacting element 4 is configured as a disk 4. The disk 4 includes a friction aid 6, configured as conical or annular structure, on a first side 4a, referred to as joint side 4a, of the disk 4, and an outer contour 7, provided with at least one opening 5, on a second side 4b, opposite the joint side 4a of the disk 4, for the receiving of the disk 4 in an insertion contour corresponding to a welding tool. The contacting of the electrical component with the disk 4 can be affected, for example, via an interference- or friction-fit.

Here the method step 120 of the material-bonded connecting can be affected by rotation-friction welding, ultrasound welding, or resistance welding.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A device for the contacting of a conductor with an electrical component, the device including:
a flat conductor made of aluminum; and
a contacting element connectable in a material-bonded manner with the flat conductor, wherein the contacting element comprises a copper material, wherein: the contacting element is configured as a disk, the disk includes a friction aid, configured as conical or annular structure, on a first side of the disk, and
the disk includes an outer contour, provided with at least one opening, on a second side, opposite the first side of the disk, for receiving the disk in an insertion contour corresponding to a welding tool.

2. The device according to claim 1, wherein the at least one opening of the outer contour of the disk is configured as a notch.

3. The device according to claim 1, wherein the at least one opening of the outer contour of the disk includes at least one angularly formed section.

4. The device according to claim 1, wherein the at least one opening of the outer contour of the disk includes at least one longitudinally formed section.

5. The device according to claim 1, wherein the disk includes a centrally oriented bore, wherein the centrally oriented bore is configured as a slot.

6. The device according to claim 1, wherein the disk is partially silvered.

7. The device according to claim 1, wherein the disk is nickel-plated.

8. The device according to claim 1, wherein the disk is partially tinned.

9. The device according to claim 1, wherein the disk has a shape contour for the realizing of a coding of a contacting point of the disk.

10. A method for the contacting of a conductor with an electrical component, the method comprising:
providing a flat conductor made of aluminum; and
material-bonded connecting of the flat conductor with a contacting element,
wherein the contacting element comprises a copper material,
wherein the contacting element is configured as a disk,
wherein the disk includes a friction aid, configured as conical or annular structure, on a first side of the disk, and
wherein the disk includes an outer contour, provided with at least one opening, on a second side of the disk, opposite the first side of the disk, for the receiving of the disk in an insertion contour corresponding to a welding tool.

11. The method according to claim 10, wherein the material-bonded connecting is affected by welding.

12. The method according to claim 11, wherein the welding is rotation friction welding.

13. The method according to claim 11, wherein the welding is ultrasound welding.

14. The method according to claim 11, wherein the welding is resistance welding.
